(19) United States
(12) Patent Application Publication
(10) Pub. No.: US 2007/0158525 A1
(43) Pub. Date: Jul. 12, 2007

(54) Reinforced pipe-hinge slide lock

(76) Inventor: Charles H. Anderson, Rochester, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(21) Appl. No.: 11/710,326

(22) Filed: Feb. 23, 2007

Related U.S. Application Data
(63) Continuation-in-part of application No. 10/928,031, filed on Aug. 27, 2004, now Pat. No. 7,182,042.
(60) Provisional application No. 60/498,057, filed on Aug. 27, 2003.

(51) Int. Cl. F16M 13/00

(52) U.S. Cl. 248/514; 248/156; 248/121

(57) ABSTRACT

A reinforced pipe hinge includes first and second elongate hinge members, the first hinge member having stem and tail portions. A first reinforcement member is received within the stem portion and includes a main body portion and a pair of axially extending struts, the struts defining a channel therebetween. The second hinge member has a first end pivotally attached to the first hinge member at a pivot point located between the stem and tail portions to enable pivoting movement of the hinge device between an extended position and an articulated position. A second reinforcement member is secured to the second hinge member and has a tongue pivotally received within the channel. The first and second hinge members are in aligned coaxial relation and the tail portion engages the second hinge member when the first and second hinge members are in the extended position. A fastener releasably secures the first and second hinge members in the extended position.

### CROSS-REFERENCE TO RELATED APPLICATIONS

This application claims priority, as a continuation-in-part type application, under 35 U.S.C. § 120 to U.S. patent application Ser. No. 10/928,031, filed Aug. 27, 2004, now pending, which properly claimed the benefit under 35 U.S.C. § 119(e) of U.S. provisional application Ser. No. 60/498,057 filed Aug. 27, 2003. Each of the aforementioned applications is incorporated by reference in its entirety.

### BACKGROUND

The present disclosure relates generally to a hinge and more particularly, a self-latching pipe hinge mechanism. The present disclosure will be described herein primarily by way of reference to devices which may be used to support hanging bird feeders, hanging plants, or the like, where the load must be supported at some distance from the ground for security or visibility while retaining accessibility for replenishment or maintenance and will be described herein primarily in reference thereto. However, it will be recognized that the present disclosure may be employed in connection with all manner of support structures for hanging or suspending objects above a surface. Other uses include but are not limited to flag poles, volleyball, basketball, or other net supports or poles, utility or decorative light poles, awnings, umbrellas, sun shades, outriggers, and the like.

There are numerous ways to mount a bird feeder. There seem to be two prevalent pole-based solutions. The feeder-on-top where the feeding device is mounted at the top of a fixed pole and the hanging feeder where the feeder is suspended from a bracket or the top of an offset section that loops vertically around the feeder to maintain the center of gravity of the feeder over the base of the pole. The lower end of both of these is either embedded in the ground or fastened to a building or some sort of base. These and most of the other existing pole based solutions and accessories seem to adequately address the issues of security and visibility. Security and visibility, up to some degree, improve as a function of height. Accessibility varies inversely with height. Stepladders are necessary for refilling higher pole mounted bird feeders with the exception of the types that separate in the middle so that the top section can be lifted out of the bottom section allowing the feeder to be lowered for replenishment. This arrangement severely limits the size and weight of the feeder that can deployed in many cases and therefore shortens the time between necessary refills. Older or more frail individuals might have difficulty lifting or not be able to lift some of the larger, longer lasting feeders into place when full and therefore might have to refill more often or forego refilling entirely in cold or inclement weather.

Accordingly, the present disclosure contemplates a new and improved pipe hinge, and bird feeder apparatus and method incorporating the same, which overcome the above-referenced problems and others.

### SUMMARY

The tilting/tipping bird feeder pole incorporating the pipe-hinge slide lock technology provides the possibility for many individuals who might otherwise be severely limited, to potentially utilize larger heavier feeders that accommodate more birds and hold more food, providing longer periods between refills. The tilt-pole /pipe-hinge in accordance with the present disclosure is preferably a heavy-duty assembly fabricated from steel pipe instead of lighter tubing as are most other types of bird feeder poles. In a preferred aspect, the pole is designed to be shipped in three sections and easily assembled in the field with readily available tools. The three sections consist of a top section bent to form a vertical loop around the bird feeder so that the feeder hangs directly above the base of the pole for balance, a center section which is the pipe-hinge and slide lock, and a bottom or base section, preferably made from a larger diameter pipe for additional strength. In an especially preferred embodiment, the base section is terminated at the bottom with a pointed plug designed to make driving the base pipe into the ground easier and more importantly to force the displaced earth to compact around the base section instead of filling the pipe thus making the surrounding earth firmer and the base section more stable in the ground.

The operation of the pole is intended to be easy even in the case where the operator might be small or frail or the bird feeder might be large and heavy. Such an operator might be able to lift the slide latch with one hand and lower the pole and empty feeder with the other to the point where the slide latch is captive above the pivot point and then lower the pole and feeder to the ground with both hands. Such an operator might then, after filling the feeder, be able to raise the feeder to the upright position with both hands and the full pushing strength of the body without the need to manually operate the gravity activated slide latch. The tailpiece of the upper hinge section keeps the operator from possibly encountering a situation wherein because of the mass of the upper pole section and the full feeder, the pole top might tend to pass the vertical and continue back to the down position on the other side before the slide latch can drop into the down or locked position. Still further benefits and advantages of the present disclosure will become apparent to those skilled in the art upon a reading and understanding of the preferred embodiments.

### BRIEF DESCRIPTION OF THE DRAWINGS

The invention may take form in various components and arrangements of components, and in various steps and arrangements of steps. The drawings, wherein like reference numerals refer to like or analogous components throughout the several views, are only for purposes of illustrating preferred embodiments and are not to be construed as limiting the invention.

FIG. 1 is a side view of the bird feeder application of the pipe-hinge slide lock in the upright or locked position.

FIG. 2 is a side view of the bird feeder application of the pipe-hinge slide lock in the unlocked rotated or down position.

FIG. 3 is a detail view of the pipe-hinge slide lock assembly.

FIGS. 4-6 are fragmentary views of an exemplary device according to the present invention illustrating optional means for assisting a user in raising the pole to the upright position.

FIG. 7 is a fragmentary cross-sectional view of a preferred pivot joint employing a solid plug and pivot bushing.

FIG. 8 is a fragmentary cross-sectional view of an embodiment employing pointed plug to facilitate embedding the lower end of the pole device in the ground.

FIG. 9 is an exploded isometric view of a bifurcated reinforcement member according to an alternative, reinforced embodiment of the present disclosure.

FIG. 10 is an exploded isometric view of a bifurcated reinforcement member according to a second reinforced embodiment of the present disclosure.

FIG. 11 is an exploded isometric view of a bifurcated reinforcement member according to a third reinforced embodiment of the present disclosure.

### DETAILED DESCRIPTION OF THE PREFERRED EMBODIMENTS

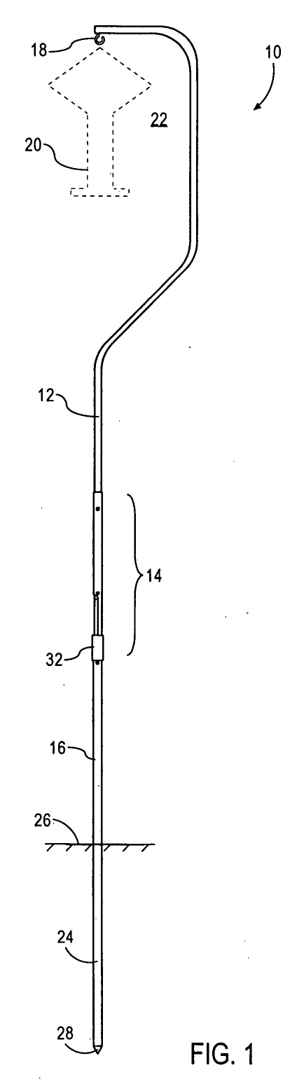

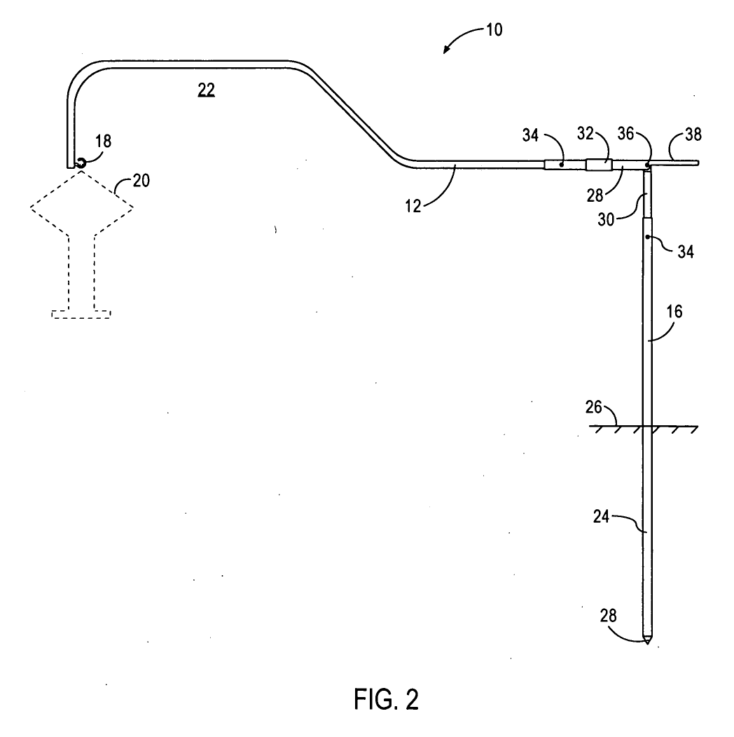

Referring now to the FIGS. 1-3, an exemplary embodiment of a bird feeder pole/plant hanger pole apparatus 10 embodying an exemplary pipe-hinge slide lock of the present invention consists of three sections, namely, a top section 12, a middle section 14, and a base section 16. The top section 12, in the depicted embodiment, may be fabricated from steel pipe and is fitted at the end of the upper extremity with a hook 18 for supporting a hanging bird feeder 20 or other object to be suspended, such as planter or the like. The hook 18 is preferably fabricated from steel although other materials are contemplated.

The top section 12 is bent in such a fashion as to provide a clearance or opening 22 for receiving the bird feeder 20 (for the sake of brevity, the item to be suspended will be described herein primarily by way of reference to the preferred embodiment wherein the hanging item is a bird feeder; however it will be recognized that this discussion is equally applicable to any other item to be suspended). This clearance or opening 22 preferably suspends the bird feeder 20 in a position which is generally centered over the lower and middle sections 14 and 16 to afford balance and support.

In the depicted embodiment, the device 10, distal end 24 of the bottom pole section 16 may be driven into the ground 26 or other surface, although other means for securing or anchoring the base section 16 to the surface 26 are contemplated. The bottom portion 16 is preferably fabricated from a larger diameter steel pipe for additional strength and to displace a larger volume of earth when driven into the ground 26. In this preferred embodiment, additional stability may be provided from compaction of the earth 26 surrounding the embedded portion of the base section 16.

The base section 16 is open at the top to receive the bottom section of the pipe-hinge slide lock assembly and, in the depicted embodiment, is terminated at the distal end 24 with a pointed, e.g., conical, plug 26. As best seen in FIG. 8, the pointed plug 26 is designed to make driving the base pipe into the ground easier and to force the displaced earth to compact around the base section, instead of filling the distal pipe end 24 with earth, thus making the surrounding earth firmer and the base section more stable in the ground 26. It will be recognized that other methods of embedding or securing the base section to the ground, floor, or other surface are also contemplated.

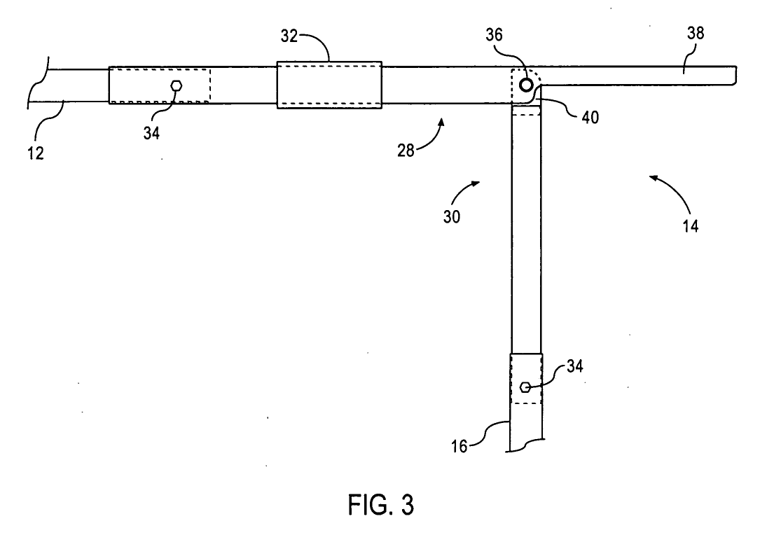

The middle section, or pipe-hinge slide lock assembly, 14 is best seen in FIG. 3, and consists of three main pieces, namely, a hinge top or cantilever section 28, a hinge bottom portion 30, and a sliding latch or sleeve 32. The hinge top section may be fabricated, for example, from steel pipe and, in the depicted embodiment, is adapted to receive the top section 12 telescopically therewithin. The hinge top section 28 may be of the same diameter as pole bottom or base section 16. The hinge top section 28 and the top section 12 may be secured in fixed telescoping relation via a bolt or retention pin 34, e.g., passing through aligned holes formed in the respective members 12 and 28.

As described above, the middle section top portion 28 is open at the top to receive the bottom end of the smaller diameter pole top section 12. Approximately centrally located along the length of the hinge top section 28 is a hinge or pivot pin 36, which is preferably welded or otherwise permanently secured in place. The pin 36 engages an opening in the top portion of the hinge bottom section 30. An optional bearing may be provided as described in detail below. Thus, in operation, the top portion 28 forms the movable part of a rotating pivot point about the hinge/pin 36.

The hinge top section 28 further includes a cantilevered tail section 38 extends past the pivot pin or hinge point 36. The cantilevered tail section 38 is preferably integrally formed with the hinge top section 28 and, in the depicted embodiment, is formed by removing approximately one-half of the circumference of the pipe material forming the hinge top section 28 that extends beyond the pivot point 36. Thus, in the depicted embodiment, the tail section 38 is approximately semicircular in cross-sectional shape. The hinge bottom section 30 is preferably slightly smaller in diameter than the hinge top section 28 so as to enable the hinge bottom section to fit within the tail section 38 when the hinge top portion 28 is moved into the upright position (see FIG. 1). For example, the outer diameter of the bottom hinge section 30 may be roughly equal to the inner diameter of the hinge top section 28. The hinge bottom portion 30 and the top pole section 12 may be of the same diameter. Likewise, the hinge top section 28 and the bottom pole section 16 may be of the same diameter. A portion of the hinge bottom portion 30 thus fits within and against the inward facing portion of the tail piece 38 when the hinge top and bottom portion members are coaxially aligned, i.e., when the hinge is in its upright position.

The pipe hinge portion 14 is held in an upright position by the annular slide latch piece 32 which is adapted to circumscribe the top pipe hinge section 28 when the pole is in the tilted or down position and is slidably moved in the axial direction to secure the tail section 38 against the hinge bottom section when the pole 10 is in the upright operational position. In this manner, the slide lock piece 32 keeps the hinge top section 28, and thus the pole top section 12, coaxially aligned with the hinge bottom section 30 and the pole bottom or base section 16. The hinge bottom section 30 may be fabricated from steel pipe and may be the same diameter as the pole top section 12 to allow it to fit the inside diameter of the hinge top section 28 and to be received into the upper end of the pole bottom or base section 16. In the depicted embodiment, the hinge bottom section 30 and the base section 16 are secured in fixed telescoping relation via a bolt or retention pin 34, e.g., passing through aligned holes formed in the respective members 16 and 30. In the depicted embodiment, the upper end 40 of the hinge bottom section 30 is rounded or angled to provide clearance for the inner circumference of the hinge top section 28 as the pivot joint rotates.

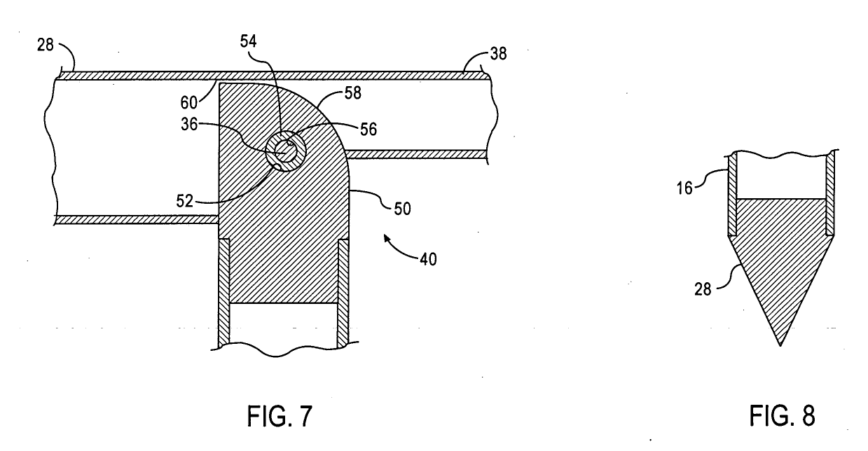

The hinge or pivot pin 36 may be provided via a number of means. For example, in an embodiment illustrated in FIG. 7, the top end 40 of the hinge bottom section 30 may be fitted with a plug 50, such as a steel plug which is drilled to accept the pivot pin 36 from the hinge top section 28 through a transversely extending opening 52. Preferably, the opening 52 is sized to accept a bearing 54, e.g., formed of bronze or other metal or metal alloy. The bearing 54 includes a through bore 56 receiving the pin 36 therethrough, e.g., for wear improvement and/or to keep rust from immobilizing the pivot point. The plug in the top end 40 of the hinge bottom section 30 is machined to a rounded and/or angled profile 58 so as to provide clearance for the inner circumference 60 of the hinge top section 28 as the pivot joint rotates. The bottom of the hinge bottom section 30 is received into the top of the pole bottom or base section 12 as described above.

The sliding latch member 32 consists of a peripheral sleeve, such as a short section of pipe, such as steel pipe. The sliding latch 32 has an inside diameter which is larger than the outside diameter of the hinge top section 28 (and the pole bottom or base section 16 when like sized pipe is used in accordance with the depicted embodiment) such that it can slide freely along the length of the pipe-hinge 14 in order to lock or unlock the assembly. The slide piece movement is restricted by a protrusion or stop at each end of the pipe hinge slide lock assembly 14, which may advantageously be the retaining pins, or more preferably bolts 34 or the like that are used to secure the top pole section 12 to the hinge top section 28 and the bottom pole section 16 to the bottom hinge section 30. In the depicted preferred embodiment, the bolts or pins 34 serve to fasten the ends of the pipe-hinge slide lock assembly 14 to the respective pole top section 12 and pole bottom section 16, although separate dedicated stop members are also contemplated.

In operation, when the slide 32 is lifted and the two sections 28 and 30 move away from coaxial alignment, it is no longer possible for the slide 32 to return to the locked position until the two sections 28 and 30 are coaxially re-aligned, e.g., by lifting the top pole section 12 to the upright position. This feature allows the possibility that an operator having once lifted the latch to lower a pole connected to the pipe-hinge mechanism might then be afforded the use of both hands to raise the pole again. In the preferred, vertical application depicted, the slide 32 automatically moves to the locked position by the force of gravity when the two hinge sections achieve coaxial alignment. This embodiment may be adapted for use in a non-vertical application by employing a spring attached to the sleeve 32 which biases the sleeve toward the locked position. To unlock the hinge, the sleeve 32 is moved against the bias of the spring and the top hinge section is moved out of axial alignment with the bottom hinge section 30. When the top hinge section 28 is moved back into axial alignment with the bottom hinge section 30, the spring urges the sleeve back to the locked position. In the preferred embodiment, the pole sections 12 and 16 and the hinge sections 28 and 30 are formed from round pipe, preferably steel or other metal or metal alloy. However, the device could be fabricated from a number of different materials exhibiting a diversity of cross-sectional shapes, including rectangular, polygonal, or other geometric cross-sectional shapes.

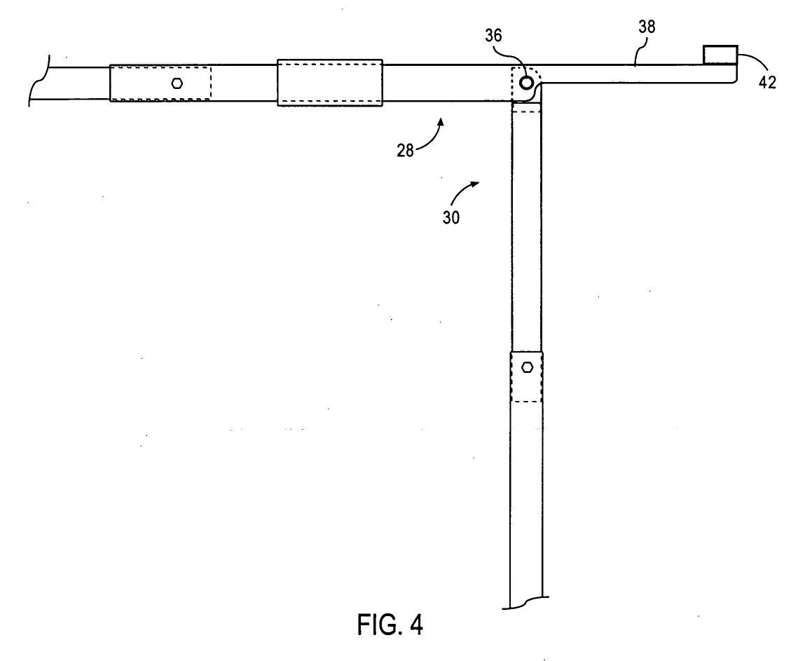

With reference now to FIG. 4, an alternative embodiment is shown having an optional counterweight or counterbalance 42, provided on the tail section 38 to further assist a user in moving the upper section between the lowered and upright positions. In the depicted embodiment, the counterweight 42 is shown somewhat schematically and may take any desired geometric configuration. Also, in the depicted embodiment, the counterweight 42 is shown attached directly to the tailpiece 38. Alternatively, however, a boom or extension (not shown) may be provided to increase the distance between the counterweight 42 and the pivot point 36. Likewise, the counterweight 42 and/or the distance between the counterweight 42 and the pivot point 36 may be made variable.

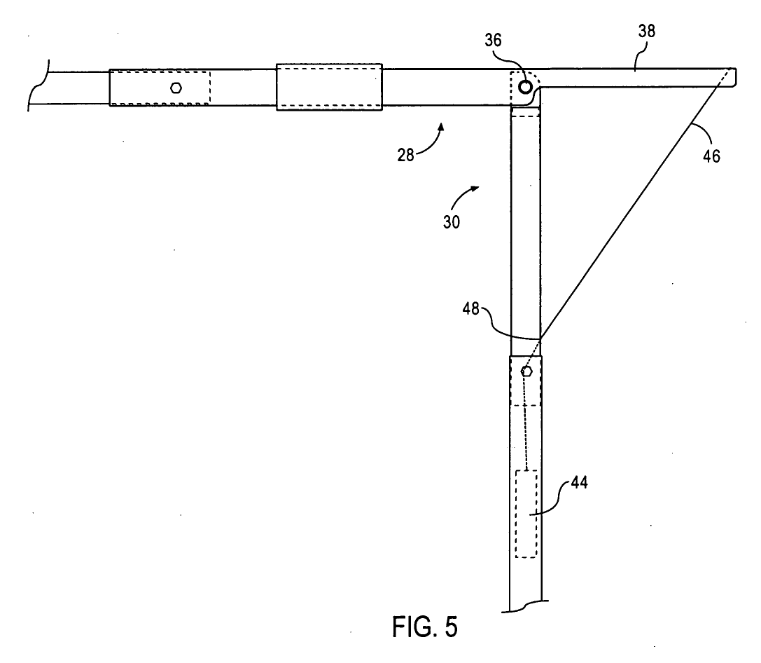

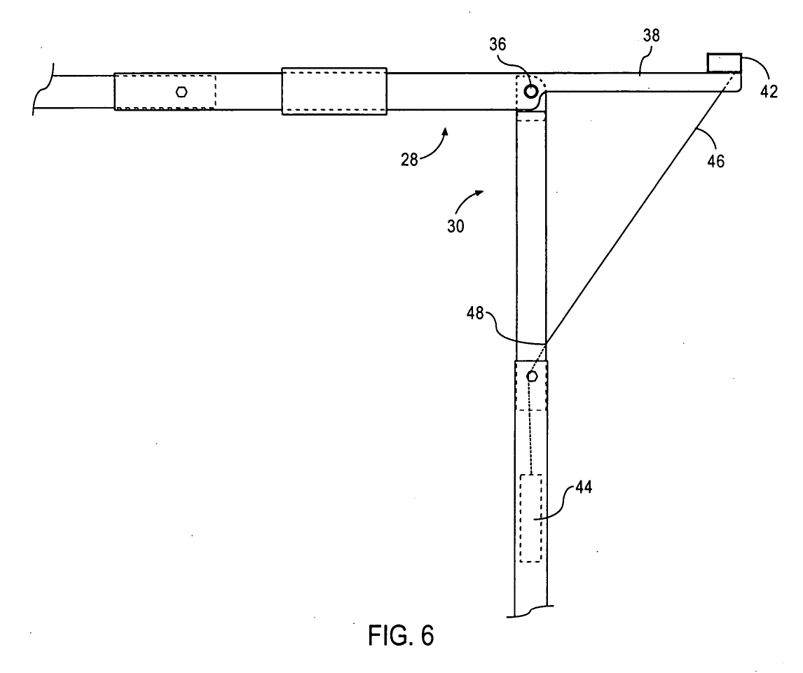

Alternatively, as shown in FIG. 5, or in addition to the counterweight 42 as shown in FIG. 6, a counterweight or other energy storage device 44 could be provided within the base pole section 16 and coupled to a movable portion of the device, preferably the tailpiece 38, via a cable or other mechanical linkage 46. In the depicted embodiment, the cable 46 cable is illustrated passing through an opening 48 in the lower hinge section 30. In operation, as the top pole portion 12 is pivoted and lowered to a tilted position, potential energy is stored by the energy storage device 44 to assist the user when returning the pole to the upright position.

For example, in the case of a counterweight 44, energy is stored as the weight is lifted to a higher position. Alternatively, the energy storage device 44 may be a spring, such as a helical spring, preferably contained within the tubular portion 16 and coupled to a movable portion of the unit 10. For example, by securing the cable/coupler 46 to a first end of the spring and securing the opposite end within the pole base 16, energy may be stored as increased spring tension when the top section 12 is pivoted to a lowered position. This increased spring tension serves to bias the pole section 12 back toward the upright position, thereby storing energy to assist the user in returning the pole to its upright position. Other devices are contemplated for use as the optional energy storage device 44 for assisting the user in returning the upper pole section 12 to its upright position, such as an air piston and cylinder assembly, or the like.

Also, combinations of such energy storage devices may be employed. For example, in FIG. 6, an external counterweight 42 as described above is employed in conjunction with an internally mounted energy storage device 44 as described above.

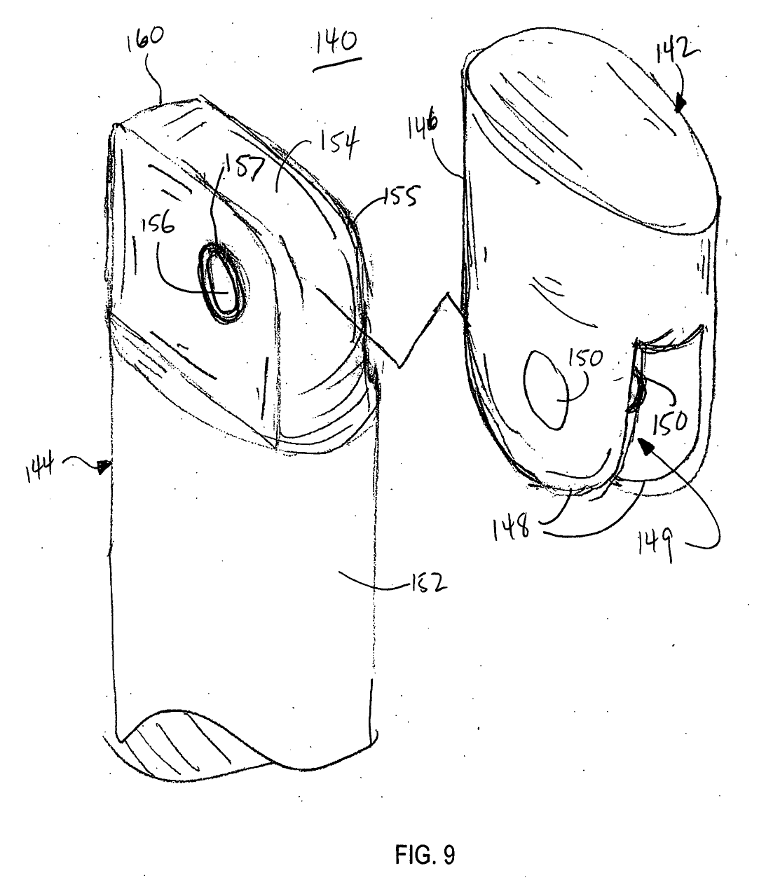

Referring now to FIG. 9, there is shown a bifurcated reinforcement member referred to generally as 140, which may advantageously be used, for example, wherein the hinge member herein might be required to be strengthened. The bifurcated reinforcement member 140 includes an upper member 142 and a lower member 144.

The upper reinforcement member 142 includes a main body portion 146 and a pair of struts or sidewalls 148 extending therefrom and defining a channel 149 therebetween. Aligned openings 150 are formed in each of the struts 148. The lower reinforcement member 144 includes a main body portion 152 and a tongue 154 extending upwardly therefrom. An opening 156 passes through the tongue 154. The upper and lower reinforcement members 142,144, are preferably formed of a solid material, preferably a metal or metal alloy, and may be manufactured, for example, by casting or molding, machining, or a combination of such processes. The illustrated embodiment is adapted for use with pole sections having a circular cross-sectional shape, although other geometrical cross-sectional shaped are contemplated.

The upper reinforcement member 142 is dimensioned so as to be inserted into the hinge top section 28 such that the openings 150 are in alignment with the corresponding openings in the hinge top section 28 for receiving the pivot pin 36. The upper reinforcement member 142 may optionally be secured in place within the hinge top section 28, e.g., via welding, mechanical fastener, or the like.

The lower reinforcement member 144 is dimensioned so as to be inserted into the lower hinge section 30 such that the tongue 154 protrudes therefrom. The lower reinforcement member 144 may optionally be secured in place within the lower hinge section 30, e.g., via welding, mechanical fastener, or the like.

In assembling a reinforced hinge employing the reinforcement member 140, the upper and lower members 142,144 are inserted into the upper and lower hinge sections 28, 30, respectively as described above. The tongue 154 is inserted into the channel 149 such that the opening 156 is in alignment with the corresponding openings 150 in the struts 149. The opening 156 may optionally include an annular bushing 157 which may be made of a durable material for reducing wear on the lower reinforcement member 144 from repeated pivoting movement about pivot pin 36.

The tongue 154 may include a radiused, rounded, or angled corner 155 to permit pivoting movement of the upper member 142 in relative thereto, e.g., in a direction theretowards. The depicted embodiment 140 also includes a nonradiused corner 160 to prevent or inhibit relative pivoting movement in the opposite direction. The pivot pin 36 is then received through the openings 150, 156, and the corresponding aligned openings in the upper hinge section 28.

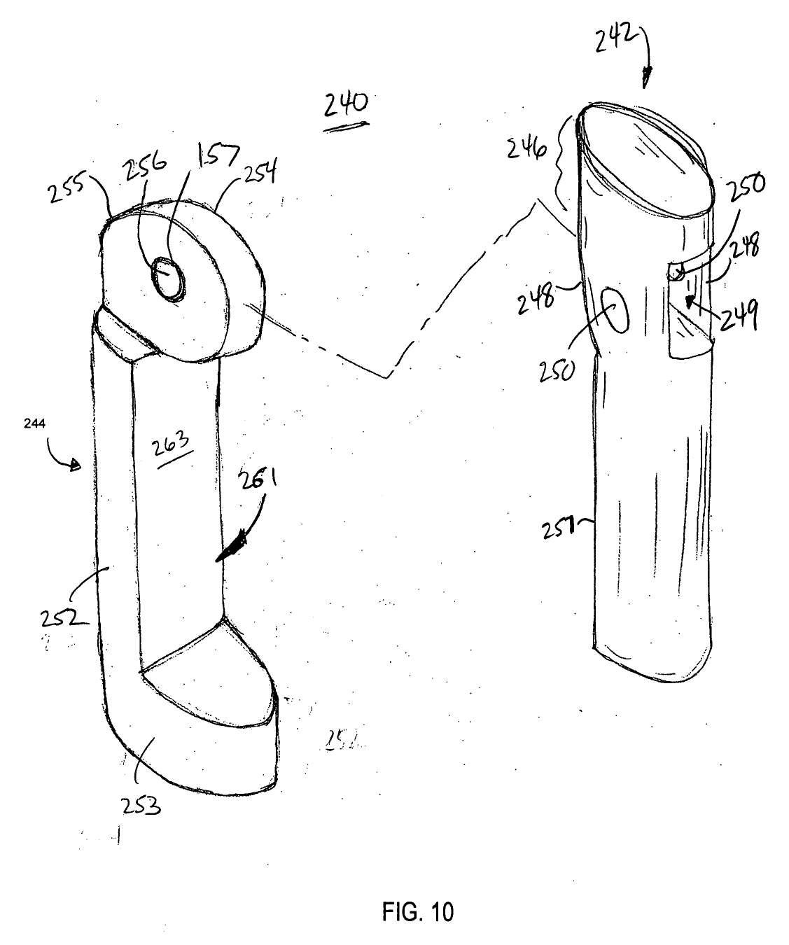

Referring now to FIG. 10, there is shown a second bifurcated reinforcement member referred to generally as 240 of a type that may advantageously be used, for example, wherein the hinge member herein might be required to be strengthened. The bifurcated reinforcement member 240 includes an upper member 242 and a lower member 244.

The upper reinforcement member 242 includes a main body portion 246 and transverse opening or channel 249 defining a pair of struts or sidewalls 248. Aligned openings 250 are formed in each of the struts 248. A tail portion extends 251 downwardly from the main body portion 246.

The lower reinforcement member 244 includes main body portion 252 having an enlarged base 253, a tongue 254, and a cutaway region 261 extending between the enlarged base and the tongue. An opening 256 passes through the tongue 254. The upper and lower reinforcement members 242, 244, are preferably formed of a solid material, preferably a metal or metal alloy, and may be manufactured, for example, by casting or molding, machining, or a combination of such processes.

The upper reinforcement member 242 is dimensioned so as to be inserted into the hinge top section 28 such that the openings 250 are in alignment with the corresponding openings in the hinge top section 28 for receiving the pivot pin 36. The upper reinforcement member 242 may optionally be secured in place within the hinge top section 28, e.g., via welding, mechanical fastener, or the like.

The enlarged base portion 253 is dimensioned so as to be inserted into the lower hinge section 30 such that the cutaway region 261 and the tongue portion 254 protrude therefrom. The enlarged base portion 253 may optionally be secured in place within the hinge lower section 30, e.g., via welding, mechanical fastener, or the like.

In assembling a reinforced hinge employing the reinforcement member 240, the upper and lower reinforcement members 242, 244 are inserted into the respective upper and lower hinge sections 28, 30 as described above. The tongue 254 is inserted into the channel 249 such that the opening 256 is in alignment with the corresponding openings 250 in the struts 249. The opening 256 may optionally include an annular bushing 157 as described above.

The tongue 254 may include a radiused, rounded, or angled corner 255 to permit pivoting movement of the upper member 242 relative thereto and in a direction theretowards. The pivot pin 36 is then received through the openings 250, 256, and the corresponding aligned openings in the upper hinge section 28.

In operation, the tail section 251 of the reinforcement upper member 242 is aligned with and reinforces the tail section 38 of the top hinge member 28. When the reinforcement members 242 and 244 are in the extended, axially-aligned position, the tail portion 251 is received within the cutaway portion 251 and abuts an upstanding wall 263 thereof to reinforce the tail 38 and prevent pivoting movement beyond the axially aligned or upright position.

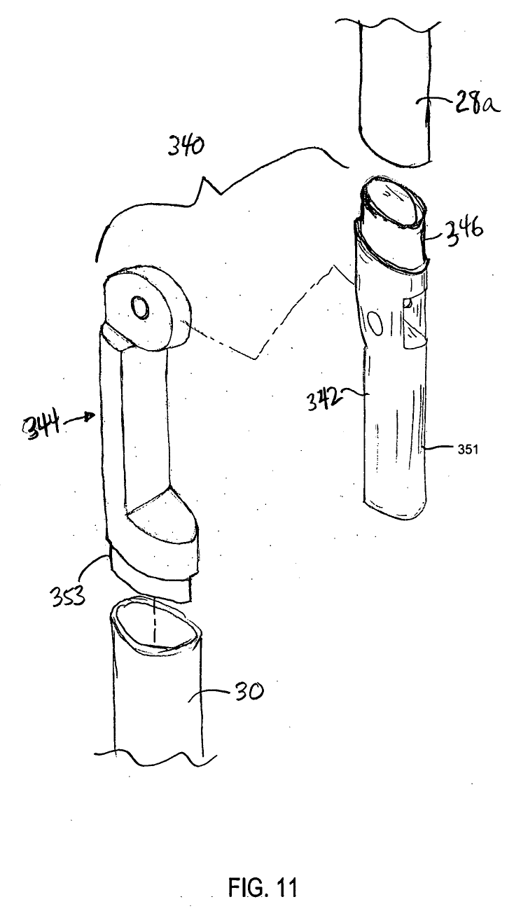

A further alternative heavy-duty or reinforced embodiment appears in FIG. 11 and includes a reinforcement member 340 having upper and lower sections 342 and 344, respectively. The reinforcement member 340 is as described above by way of reference to the reinforcement member 240, except that may be sized to match the overall diameter of the upper and lower pole sections 28a and 30. The upper reinforcement member 342 has a reduced diameter portion 346 adapted to fit telescopically into the modified top hinge section 28a and the lower reinforcement member has a reduced diameter portion 353 adapted to fit within the lower hinge portion 30. The modified top hinge section 28a may be as described above by way of reference to the section 28, but wherein it is truncated so as to eliminate the opening for receiving the pivot pin 36 and to eliminate the tail section 38. In this manner, the tail section 351 of the upper reinforcement member 342 is the sole tailpiece of the pipe hinge herein.

The invention has been described with reference to the preferred embodiment. Modifications and alterations will occur to others upon a reading and understanding of the preceding detailed description. For example, the middle hinge section 14 need not be separable from the top and bottom pole sections 12 and 16, respectively. Thus, one or both of the upper hinge section 28 and lower hinge section 30 may be integrally formed with the respective top and base pole section 12 and 16. In one embodiment, the pole top section 12 is integrally formed with hinge cantilever section 28, and the pole base section 16 is separately attachable to lower hinge pivot section 30. In another alternative embodiment, the pole top section 12 is separately attachable to the hinge cantilever section 28, and the pole base section 16 is integrally formed with the lower pipe hinge pivot section 30. In yet another alternative embodiment, the pole top section 12 is integrally formed with the hinge cantilever section 28, and the pole base section 16 is integrally formed with the lower hinge section 30. Also, it will be recognized that the cantilever and pivot sections 28 and 30 may be reversed from the depicted preferred embodiment such that the cantilever hinge section 28 is retained within or integrally formed with the base pole portion 16 and the lower hinge pivot section 30 engages or is integrally formed with the pole top section 12. Also, the depicted preferred embodiment illustrates the various sections fastened in affixed telescopic relation using a bolt or pin passing through aligned holes. However, other fastener types may also be employed, such as complimentary threaded section ends, mating flanges, clamping rings, and the like. It is intended that the invention be construed as including these and other modifications and alterations insofar as they come within the scope of the appended claims or the equivalents thereof.

Having thus described the preferred embodiments, the invention is now claimed to be:

1. A hinge device, comprising:
first and second elongate hinge members;
said first hinge member having a stem portion and a tail portion;
a first reinforcement member received within said stem portion, said first reinforcement member including a main body portion and a pair of struts extending axially therefrom, said struts defining a channel therebetween;
said second hinge member having a first end pivotally attached to the first hinge member at a pivot point located between the stem portion and tail portion of the first hinge member to enable pivoting movement of the hinge device between an extended position and an articulated position;
a second reinforcement member secured to the second hinge member and having a tongue pivotally received within said channel;
said first and second hinge members being in aligned coaxial relation and said tail portion engaging said second hinge member portion when the first and second hinge members are in said extended position; and
a fastener for releasably securing the first and second hinge members in the extended position.

2. The device of claim 1, further comprising:
said fastener including an annular sleeve circumscribing said hinge device, the annular sleeve slidably movable to secure said tail portion to said second hinge member when the first and second hinge members are in the extended position.

3. The device of claim 1, further comprising:
an elongate base portion having a first end attached to the second end of said second hinge member and a second end adapted to engage a surface; and
a support arm having a first end attached to the stem portion of the first hinge member and a second end opposite the first end adapted to be attached to an object.

4. The device of claim 3, further comprising:
a hook attached to the second end of the support arm for suspending an object above said surface.

5. The device of claim 3, wherein at least a portion of said support arm is curved such that the object will be suspended substantially in line with a longitudinal axis of said base portion when the object is attached to the second end of the support arm and the first and second hinge members are in said extended position.

6. The device of claim 3, further wherein:
the second end of the second hinge member is telescopically received within the first end of the base portion and further comprising a first fastener securing the second end of the second hinge member to the first end of the base portion; and
the first end of the support arm is telescopically received within the stem portion of the first hinge member and further comprising a second fastener securing the first end of the support arm to said stem portion.

7. The device of claim 6, wherein one or both of said fasteners includes a protruding portion which protrudes outwardly from an exterior facing surface of the base portion and engages with an axially movable annular sleeve when the first and second hinge members are in said extended position to limit the extent of axial movement of said sleeve.

8. The device of claim 1, further comprising one or both of:
said tail section having a curved cross-sectional profile which is complimentary and mating with an aligned, facing surface of said second hinge member when the first and second hinge members are in said extended position; and
an energy storage device for storing potential energy when said first and second hinge members are moved from the extended position to an articulated position, said stored potential energy for assisting a user in moving the first and second hinge members from the articulated position back to the extended position.

9. The device of claim 2, wherein said annular sleeve is adapted to automatically move to lock the hinge under the influence of gravity when the first and second hinge members are moved to the extended position.

10. The device of claim 1, further comprising:
said first reinforcement member having a tail section extending from said struts;
said second reinforcement member having a base portion adapted to be received within said second hinge member and a cutaway region extending between said tongue and said base portion, said cutaway region adapted to matingly receive said first reinforcement member tail section when the first and second hinge members are in the extended position.

11. A hinge device, comprising:
first and second elongate hinge members;
a first reinforcement member received within said first hinge member, said first reinforcement member including a main body portion and a pair of struts extending axially therefrom, said struts defining a channel therebetween, and said first reinforcement member further having a tail section extending from said struts;
said second hinge member having a first end pivotally attached to the first hinge member to enable pivoting movement of the hinge device between an extended position and an articulated position;
a second reinforcement member secured to the second hinge member and having a tongue pivotally received within said channel, said second reinforcement member having a base portion adapted to be received within said second hinge member and a cutaway region extending between said tongue and said base portion, said cutaway region adapted to matingly receive said first reinforcement member tail section when the first and second hinge members are in the extended position; and
a fastener for releasably securing the first and second hinge members in the extended position.

12. The device of claim 11, further comprising:
said fastener including an annular sleeve circumscribing said hinge device, the annular sleeve slidably movable to secure said tail portion to said second hinge member when the first and second hinge members are in the extended position.

13. The device of claim 11, further comprising:
an elongate base portion having a first end attached to the second end of said second hinge member and a second end adapted to engage a surface; and
a support arm having a first end attached to the stem portion of the first hinge member and a second end opposite the first end adapted to be attached to an object.; and
an optional hook attached to the second end of the support arm for suspending an object above said surface.

14. The device of claim 13, wherein at least a portion of said support arm is curved such that the object will be suspended substantially in line with a longitudinal axis of said base portion when the object is attached to the second end of the support arm and the first and second hinge members are in said extended position.

15. The device of claim 13, further wherein:
the second end of the second hinge member is telescopically received within the first end of the base portion and further comprising a first fastener securing the second end of the second hinge member to the first end of the base portion; and
the first end of the support arm is telescopically received within the stem portion of the first hinge member and further comprising a second fastener securing the first end of the support arm to said stem portion.

16. The device of claim 15, wherein one or both of said fasteners includes a protruding portion which protrudes outwardly from an exterior facing surface of the base portion and engages with an axially movable annular sleeve when the first and second hinge members are in said extended position to limit the extent of axial movement of said sleeve.

17. The device of claim 11, further comprising an energy storage device for storing potential energy when said first and second hinge members are moved from the extended position to an articulated position, said stored potential energy for assisting a user in moving the first and second hinge members from the articulated position back to the extended position.

18. The device of claim 12, wherein said annular sleeve is adapted to automatically move under the influence of gravity to lock the hinge when the first and second hinge members are moved to the extended position.

19. The device of claim 11, further comprising:
said first reinforcement member includes a reduced diameter portion adapted to be received within said first hinge member; and
said second reinforcement member includes a reduced diameter portion adapted to be received within said second hinge member.

20. A method of accessing an object suspended above a surface, comprising:
providing an elongate base portion having a first end for engaging a surface and a second end opposite the first end;
attaching a hinge to the base section, said hinge comprising first and second hinge members;
said first hinge member having a first end engaging the second end of the second end of the base portion and a second end opposite the first end;
said second hinge member having a stem portion and a tail portion, the second hinge member pivotally attached to the second end of the first hinge member at a pivot point between the stem portion and tail portion of the second hinge member to enable movement between an extended position and an articulated position;
positioning an annular sleeve about said hinge and slidable along its length between a first, locked position in which the tail portion is secured to the first hinge member for maintaining the first and second hinge members in said extended position and a second, unlocked position in which the sleeve is aligned with said stem portion and said first and second hinge members are free to pivotally move to an articulated position.
attaching a first end of a support arm to the stem, the support arm having a second end opposite the first end for supporting said object;
moving the annular sleeve into the second, unlocked position;
pivoting the first and second hinge members until the support arm second end is within reach;
attaching an object to be suspended to the second end of the support arm;
raising the object by pivoting the first and second hinge members into said extended position; and
moving the annular sleeve into said locked position.
